(19) United States
(12) Patent Application Publication
(10) Pub. No.: US 2013/0279993 A1
(43) Pub. Date: Oct. 24, 2013

(54) LOW IMPACT STATION FOR PNEUMATIC TRANSPORT SYSTEM

(71) Applicants: Ray Castro, Denver, CO (US); Gary Cumro, Black Hawk, CO (US)

(72) Inventors: Ray Castro, Denver, CO (US); Gary Cumro, Black Hawk, CO (US)

(73) Assignee: Translogic, Denver, CO (US)

(21) Appl. No.: 13/453,106

(22) Filed: Apr. 23, 2012

(51) Int. Cl. B65G 51/26

(52) U.S. Cl. CPC B65G 51/26
USPC 406/154

(57) ABSTRACT

Provided herein is a pneumatic tube system station that reduces the impact applied to carriers received by the station. More specifically, the station utilizes a compliant ramp that reduces impact shock applied to carriers as they fall into receiving stations under the force of gravity.

### FIELD

The present disclosure relates to sending and receiving stations for use in a pneumatic tube transport system. More particularly, the present disclosure relates to a carrier station that reduces impacts applied to incoming carriers.

### BACKGROUND

Pneumatic tube transport systems are a well-known means for the automated transport of materials between, for example, an origination location and any one of a plurality of destination locations. A typical system includes a number of pneumatic tubes interconnected in a network to transport carriers between a plurality of user stations. That is stations are typically disposed throughout the system for dispatching carriers to other locations within the pneumatic transport system, for receiving carriers from other locations within the system, or both. Various blowers and transfer units provide the force and path control means, respectively, for moving the carriers through the system. The pneumatic tubes that connect the various stations may be arranged in any manner. Generally, a single pneumatic tube interconnects an individual station to the network. In this arrangement, such a single pneumatic tube transports carriers to and from the station. Other portions of the network may be interconnected with dedicated incoming and outgoing pneumatic tubes.

### SUMMARY

Provided herein are systems and methods (i.e., utilities) that allow for reducing the impact applied to carriers received by a station in a pneumatic carrier system. More specifically, aspects of the presented inventions are directed to reducing impact shock applied to carriers as they fall into receiving stations under the force of gravity.

According to a first aspect, the dispatch/receiving station for a pneumatic carrier transport system is provided. The station includes a carrier port for receiving carriers into the station (e.g., from a pneumatic tube system). The station further includes a receiving surface where carriers received by the station come to rest. The carrier receiving surface is at a vertical position below the carrier port and carriers pass between the carrier port and the receiving surface under the force of gravity. The station further includes a ramp having a first end that is disposed proximate to the carrier port and a second end that is disposed proximate to the receiving surface. A curved body portion extends between the first end and the second end. Accordingly, carriers that are received by the carrier port in a substantially vertical orientation are received by the first end of the ramp and slide down a surface of the curved body to the second end of the ramp where the carriers come to rest in a substantially horizontal orientation. The ramp allows for translating the position of a carrier from a vertical orientation to a horizontal orientation. To provide such transition, the first end of the ramp is primarily vertical while a second end of the ramp is primarily horizontal and the curved portion extending there between allows for a sliding transition.

In order to further dissipate the potential energy of the carrier received at the carrier port, a surface of the ramp that receives the carrier is deflectable under the weight of the carrier. To provide such deflection, the ramp further includes an open frame having first and second spaced rods or rails. A compliant surface extends over the open frame between the first and second rails. Accordingly, when carriers are received by the ramp, the carriers contact the compliant surface between the first and second rails. The compliant surface is configured to deflect from static position to a deflected position in response to the weight of the pneumatic carrier being disposed thereon. In conjunction with the deflection of the compliant surface, the rails of the open frame may be designed to deflect inward (i.e., toward one another) in response to the weight of the pneumatic carrier.

In a further arrangement, the compliant surface is formed of a sleeve that extends not only over the space between the first and second rails but around the rails to define an interior space. This interior space, in one arrangement, houses a pad formed of a compressible material. The pad, like the compressible surface of the ramp deflects from a static position to deflected position in response to the weight of the pneumatic carrier being disposed on an outside surface of the sleeve member.

According to another aspect, a method is provided for use with a pneumatic dispatch/receive station of a pneumatic carrier transport system. The method includes receiving a carrier at an inlet port of a carrier station. This port is disposed vertically above a receiving surface where the carrier received by the station comes to rest. The method includes descending the carrier through the inlet port and, in conjunction with descending the carrier through inlet port, contacting a portion of the carrier with a surface of a curved ramp having a first end disposed proximate to the inlet port and a second end disposed proximate to the receiving surface. As a carrier continues to descend through the inlet port, it begins to slide down the surface of the ramp and is translated from a first vertical orientation to a second horizontal orientation.

In one arrangement, contacting of the carrier with a ramp occurs prior to the carrier being released by the inlet port. In this regard, the carrier is never permitted to freefall under the force of gravity. In a further arrangement, contacting also includes deflecting the surface of the curved ramp where a surface of the ramp deflects and responds to the weight of the carrier contacting the surface. In a further arrangement, the method also includes turning the carrier between the first end and the second end of the ramp such that the carrier is substantially aligned with the second end of the ramp allowing the carrier to roll off the second end of the ramp.

### BRIEF DESCRIPTION OF THE DRAWINGS

FIG. 1 illustrates an exemplary pneumatic transport system.

FIG. 2 illustrates an exemplary control system for a pneumatic transport system.

FIG. 3 illustrates an carrier for use in a pneumatic transport system.

FIGS. 4A and 4B illustrate a prior art pneumatic transport system station.

FIG. 5A is a perspective view of a ramp for use with a pneumatic transport system station.

FIG. 5B is a front view of the ramp of FIG. 5A.

FIG. 5C illustrates insertion of a compliant pad into the ramp of FIG. 5A.

FIG. 5D is a cross-sectional side view of the ramp of FIG. 5A.

FIG. 5E illustrates an open frame that is incorporated into the ramp of FIG. 5A.

FIG. 5E shows a cross-sectional view of the ramp of FIG. 5A.

FIG. 5G shows the front surface of the ramp of FIG. 5E deflected in response to receiving a carrier.

FIG. 6 illustrates a pneumatic transport system station incorporating a guide ramp.

FIGS. 7-8 illustrate the pneumatic transport system station of FIG. 6 receiving a carrier.

FIGS. 10A and 10B illustrate a guide ramp turning a carrier as it slides down the ramp.

FIG. 11 illustrates a carrier rolling out from the guide ramp.

### DETAILED DESCRIPTION

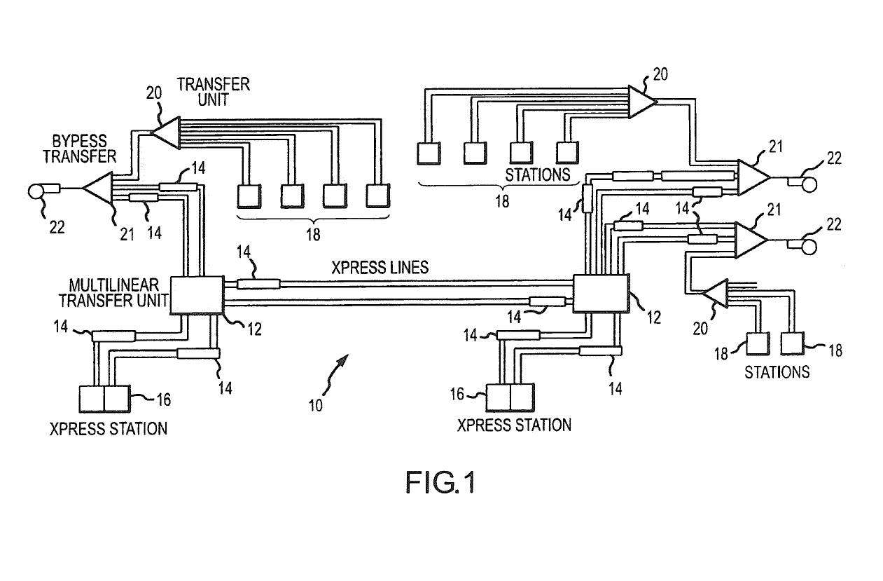

FIG. 1 illustrates an exemplary pneumatic transport system. In general, the pneumatic transport system 10 transports pneumatic carriers between various user stations 16, 18, each such transport operation being referred to as a “transaction”. At each of the user stations 16, 18, a user may insert a carrier, select/enter a destination address/identification and a transaction priority, and then send the carrier. The system determines an optimum path to route the carrier and begins directing the carrier through the system.

Interconnected with each station 16, 18 of the exemplary system 10 is a transfer unit 20 which orders carriers arriving through different tubes from a different station 16, 18 into a single pneumatic tube. This pneumatic tube is further in connection with a vacuum by-pass transfer unit 21 (i.e., a turnaround transfer unit) and a blower 22 that provides the driving pneumatic force for carrier movement. The pressure/vacuum from the blower is operative to create a pressure differential across a carrier disposed within the pneumatic tubes and causes the carrier to move through the pneumatic tubes. That is, the blower 22, transfer units and pneumatic tubes create a pneumatic zone or circuit for use in transporting carriers between first and second points within the system 10. Multiple different zones connected using transfer units 12 collectively define the pneumatic transport system 10. Within the system 10, one or more devices are employable for ordering and routing carriers to their selected destinations. One type of device is a traffic control unit (TCU) 14, which is employable to receive, temporarily store and release a number of carriers. Also included in the system 10 are multi-linear transfer units (MTUs) 12 which have functionality to direct carriers from one pneumatic tube to another pneumatic tube (e.g., between tubes in single zone or between different zones).

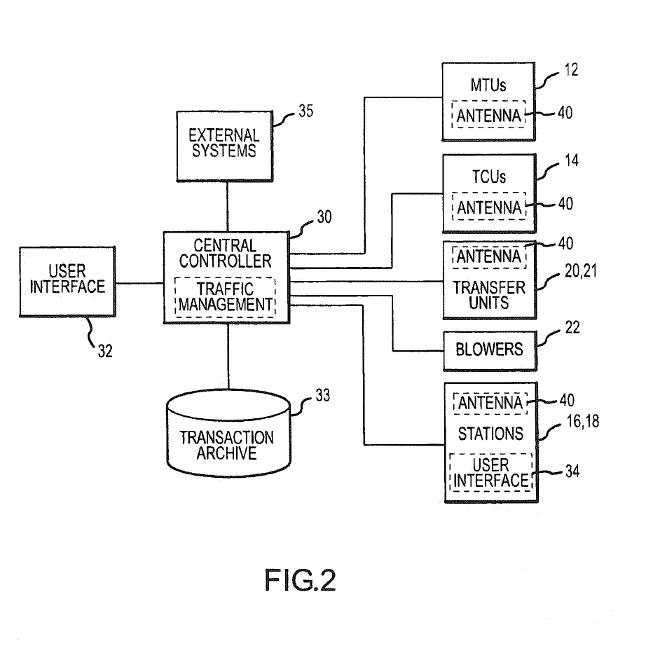

All of the components described in FIG. 1 are electronically connected to a system central controller (SCC) 30 that controls their operation and which is disclosed in the electrical system diagram of FIG. 2. The system central controller (SCC) 30 provides centralized control for the entire pneumatic carrier system 10 and may include a digital processor and memory/achieve 33. Connectable to the SCC 30 may be one or more user interfaces 32 through which a system user may monitor the operations of the system and/or manually enter one or more commands to control its operation. In addition to controlling the operation of the carrier system 10 as depicted in FIG. 1, the SCC 30 may provide additional functionality. Such functionality may include, without limitation, interconnection to external systems 35 and/or use of identification devices/antenna readers 40 that may allow for identification of carriers within the system 10. In the latter regard, a system for RFID identification within a pneumatic carrier system is described in U.S. Pat. No. 7,243,002, entitled, “System and Method for Carrier Identification in a Pneumatic Carrier System,” having an issue date of Jul. 10, 2007, the contents of which are incorporated by reference herein.

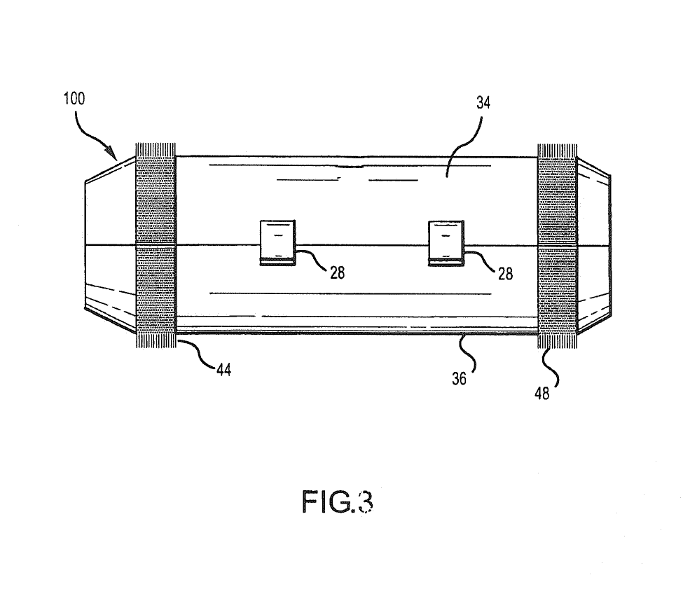

FIG. 3 illustrates one non-limiting type of carrier 100 for use with a pneumatic system. Generally, the carrier 100 is positionable between an open configuration for loading cargo on a closed position for transport. The carrier 100 includes a first shell member 34 and a second shell member 36 (e.g., clamshells) that collectively define an enclosed space (not shown) for use in carrying the cargo through the system 10. The first and second shell members 34, 36 are generally adjoinably cylindrical in cross-section for use in correspondingly cylindrical pneumatic tubes (not shown) of the system 10. At least one hinge member pivotally interconnects the first and second shell members 34, 36 for movement between the open and closed configurations. Further, at least one latch 28 allows for securing the first and second shell members 34, 36 in the closed configuration.

Included as part of the carrier 100 are a first wear band 44 and a second wear band 48 that are sized to fit snuggly within the inside surface of the pneumatic tubes of the system 10. By substantially blocking the passage of air across the carrier 100, the first and second wear bands 44, 48 create a pressure differential across the carrier 100 that pushes or draws the carrier 100 through the pneumatic tubes of the system 10.

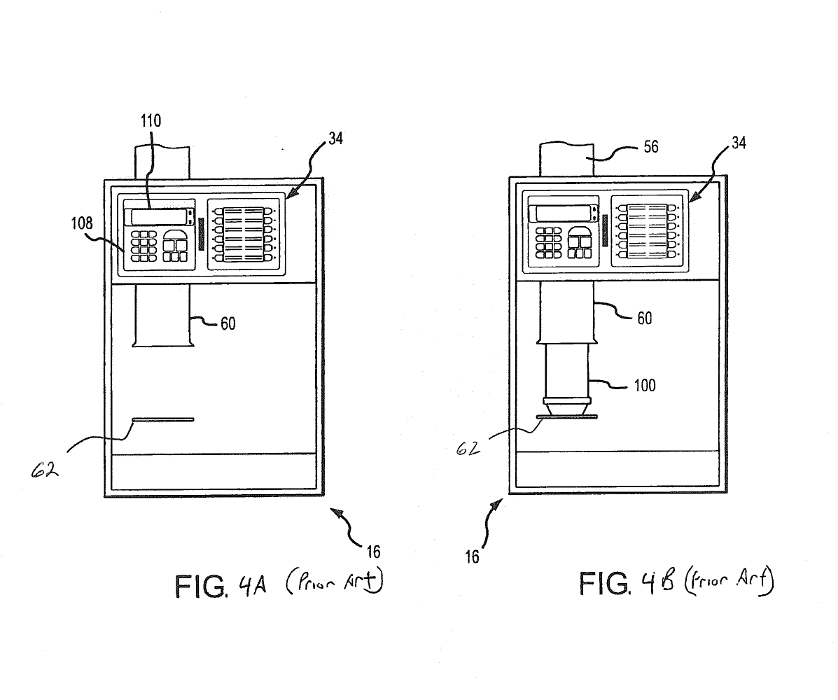

FIGS. 4A and 4B are front views of a prior art station 16 which is employable in the pneumatic carrier system 10 described herein. As shown, the station 16 includes a dispatcher connected to a pneumatic tube 56 that is employable for transporting and delivering carriers 100 to and from the station 16. Also included with the station 16 is a user interface 34 that includes a control panel 108 that has a number of interactive devices which a system user may employ for entering data including. The user interface 32 includes a display 110 which is configured to present messages relating to transaction and system status which are viewable by a system user.

A dispatcher 60 of the station is sized to receive an end of a carrier placed in the station. Positioned relative to the dispatcher 60 is a carrier holder 62 that is configured to allow a system user to place a carrier on the holder 62 and enter destination information through the control panel 108. Once all the appropriate information has been entered, the dispatcher 60 will move the carrier 100 into a pneumatic tube 56 for transport to a selected destination. Likewise, when a carrier 100 is received by the station 16, the carrier descends into the station, typically under the force of gravity, through the dispatcher 60 until it is stopped by the holder 62. In this arrangement, a user must physically remove the carrier from the holder 62 before the station can receive an additional carrier.

The healthcare industry often utilizes pneumatic tube transport systems to move patient samples and drugs from a centralized dispensing or collection point to the point of analysis or use. For example, pneumatic carriers may carry blood samples drawn at a patient's bedside or at a central collection point (such as a satellite phlebotomy lab) to a central lab for analysis and reporting. Similarly, a central pharmacy may receive a doctor's orders and dispense medications for distribution to a plurality of stations via pneumatic tube and then to the patients themselves via nurses positioned near the stations. In such systems, stations often encounter significant traffic. Accordingly, the requirement that a user remove each carrier from the station before the station receives another carrier results in lowered throughput for the station. That is, the ability to receive a single carrier creates a system bottleneck.

To alleviate the bottleneck created by requiring physical removal of a carrier from a station, some systems incorporate a station having a receiving bin. Rather than descending to a holder, which stops movement of the carrier, a carrier drops directly into the receiving bin. While effective in allowing delivery of multiple carriers free of user intervention, such stations have a number of drawbacks. Specifically, such stations impart impact shocks to the carriers and their contents as they freefall into the bin. These forces can affect the integrity, properties, and characteristics of samples and drugs received by the station. For example, a drug comprised of immiscible fluids can be mixed by agitation from the physical forces of impact. Another common example is the separation of blood components caused by impact. Likewise, impact can cause contents to spill when, for example, containers within the carrier (e.g., test tubes, IV bags etc.) break due to impact forces. Another drawback of drop-in stations is the noise generated by carriers falling unimpeded into the station. To alleviate these and other concerns, the present invention is directed to a pneumatic tube station that allows for receiving one or more carriers free of user interaction while substantially eliminating impact shock applied to incoming carriers. As the pneumatic tube station substantially eliminates impact applied to the incoming carriers, it also reduces the noise created by prior art stations.

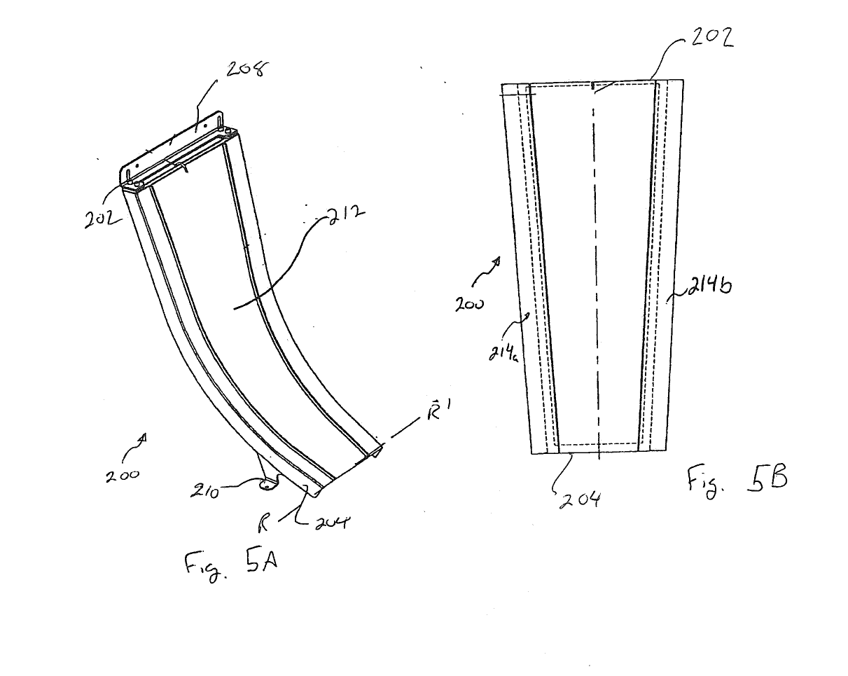

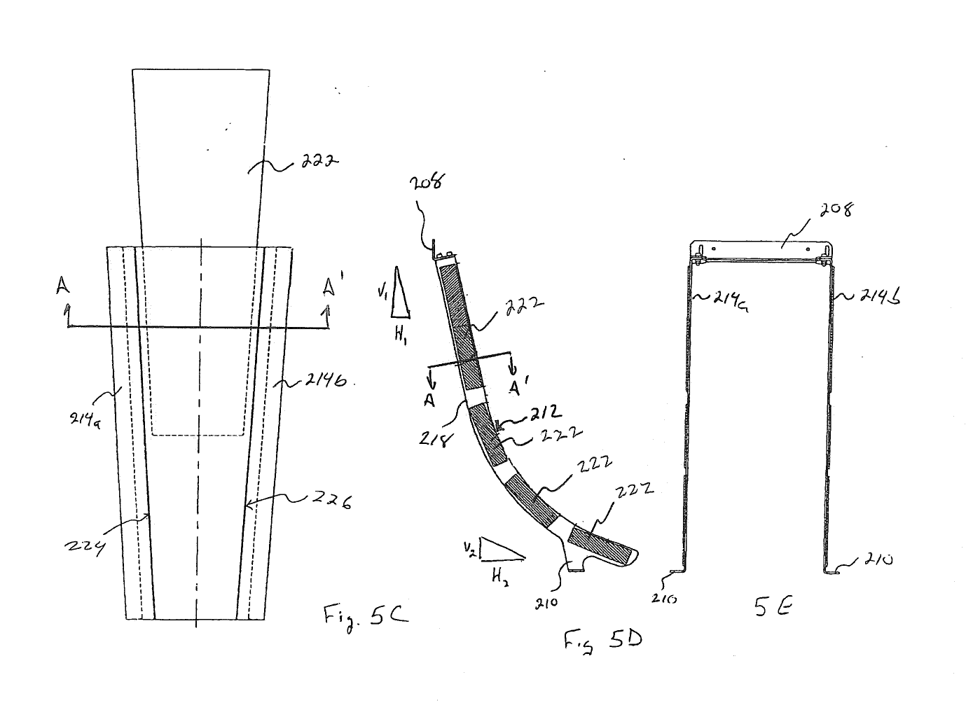

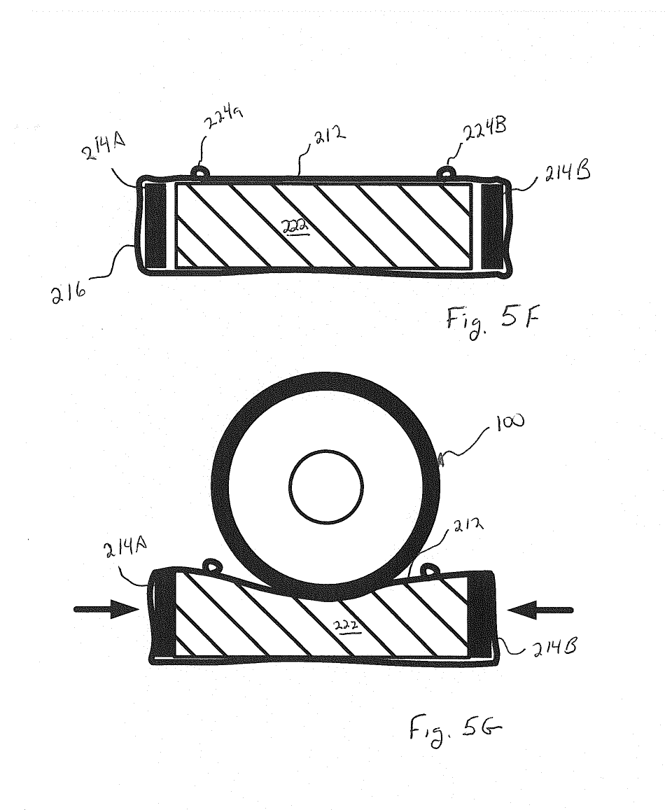

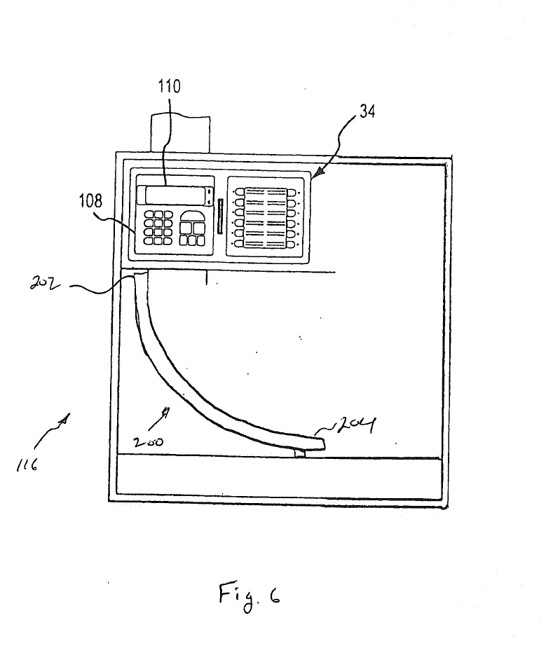

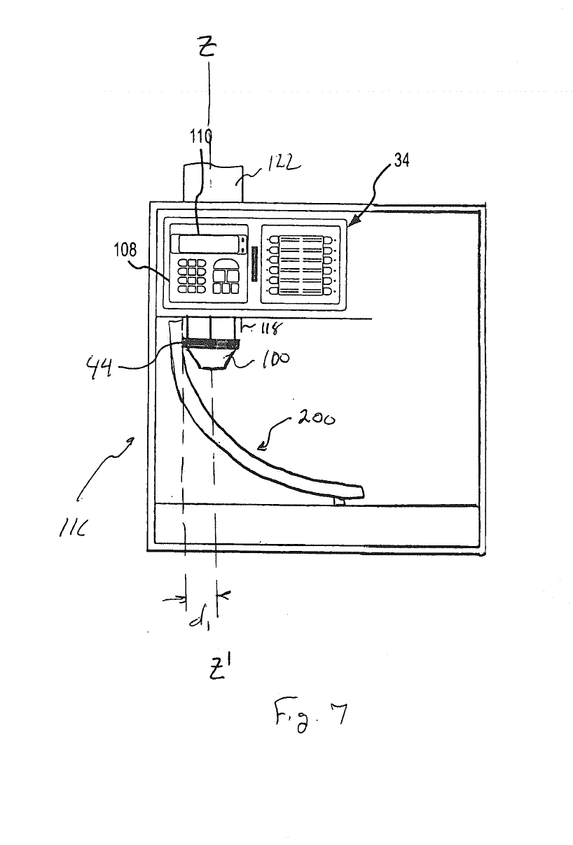

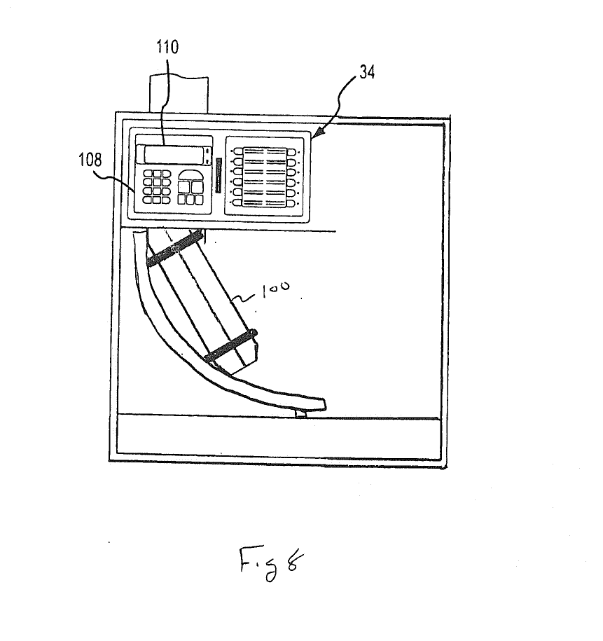

In order to reduce the impact of carriers received by a pneumatic tube system station, the systems and methods (i.e., utilities) disclosed herein utilize a guide ramp that allows for controllably descending a carrier between an inlet port of a carrier station and the support surface (e.g., bin) of the station. FIGS. 5A and 5B illustration a perspective and front view, respectively, of a guide ramp 200 in accordance with various aspects of the present disclosure. As shown, the guide ramp 200 forms a curved ramp with a first end 202 that is attached carrier station 116 approximate to the input/output port 118 of the station 116. See FIG. 6. A second end 204 of the ramp assembly 200 is adapted for interconnection approximate to the receiving floor or bin 120 of the carrier station 116. As shown in FIG. 6, a curved body section 206 extends between the first and second ends 202, 204. The curvature of the ramp 200 allows for receiving a carrier from the port 118 of the carrier station 116 and allowing it to controllably slide down the ramp 200 and into the receiving bin 120 substantially free of impact shock, as discussed herein.

To allow for attachment of the first end 202 to the carrier station 116 at a location proximate to the input port 118, the first end 202 includes a bracket 208. See FIGS. 6, 5A and 5D. In the present embodiment, the first bracket 208 is formed of an L-shaped element having one leg of the bracket interconnected to the first end 202 of the ramp 200 and a second leg of the bracket adapted for interconnection to supporting structure of a pneumatic carrier station. In this regard, the first bracket may include various apertures that allow for interconnection utilizing, for instance, threaded elements. The second end 204 of the ramp 200 includes a foot 210 that is adapted for interconnection to the support surface/bin 120 of the station 116. Again, this second bracket or foot 210 may include various apertures that allow for interconnection using one or more threaded elements that are received by a surface of the station.

To permit a carrier to smoothly slide down the ramp 200 (e.g., with little or no impact), a top portion of the ramp is primarily vertical and a bottom portion is primarily horizontal with a curved transition in between. Stated otherwise, a top portion of the ramp 200 has a steep incline where a vertical component V₁ of this ramp portion is greater than its horizontal component W₁. See FIG. 5D. In contrast, the bottom portion of the ramp 200 has a shallow to flat incline where a vertical component V₂ is less than its horizontal companion H₂. Accordingly, a middle portion of the ramp 200 transitions between these inclines.

In order to dissipate the potential energy of the carrier 100, which is received at the input port 118 a vertical distance above the receiving bin 120, the embodiment of FIGS. 5A-5D includes a flexible or compliant front surface 212 that allows for cradling a carrier as it is received by the ramp 200. The side rails, are rigid in comparison to the front surface 212 in a direction normal to the front surface. That is, these rails 214A, 214B do not deflect or do not appreciably deflect in the normal direction in response to the receipt of a carrier on the front surface 216. However, the rails 214A, 214B may deflect inward (i.e., toward one another) when the front surface 212 deflects. This allows for increased conformance of the front surface 212 to the carrier. Stated otherwise, the rail 214A, 214B are shaped to permit deflection in a first direction while resisting deflection in a second direction in response to the weight of a carrier on the front surface 212.

In response to a pressure applied by the weight of a carrier (e.g., an empty carrier) this front surface 212 is adapted to deflect and thereby absorb energy from the carrier. To allow the front surface 212 to deflect, the ramp includes an open frame formed of first and second side rails 214A and 214B. As shown in FIG. 5E, these first and second side rails 214A, 214B are interconnected on their first ends by the first bracket 208. In the present embodiment the second or lower ends of the rails 214A, 214B are not interconnected but rather are connected to a receiving station by the feet 210 located proximate to the second end 204 of the ramp. In other embodiments, a support may extend between the ends of the rails.

The deflectable member/compliant front surface 212 of the ramp 200 may be made of any appropriate material that allows for deflection under the weight of an incoming carrier. Typically, the front surface 216 will be formed to provide minimal frictional resistance. That is, this front surface is typically slick to allow the carrier to move in surface with minimal resistance. In this regard, the ramp be formed of synthetic material (e.g. nylon, cordura) or may include various coatings that are applied to the front surface. In one embodiment, the front surface 212 is formed of a textile material (e.g., a material including woven fibers). In another embodiment, the front surface 212 is formed of a polymer material. Other materials are possible and considered within the scope of the present invention. In any arrangement, as a carrier is received through the input port (See FIG. 7) a portion of the carrier 100 contacts the ramp 200 between the first and second rails 214A, 214B. Stated otherwise, the carrier contacts the front surface 212 of the ramp 200 as it descends into the carrier station 116. The deflection of this front surface 212 absorbs the momentum of the carrier as it is guided out of the input port 118 and into the bin 120 of the carrier station 116.

In one embodiment, the front surface 212 is formed of a sleeve 216 that surrounds the first and second rails 214A, 214B of the ramp 200 as shown in FIG. 5F, which is a cross-sectional view of the ramp taken on section lines A-A¹ of FIG. 5C. As shown, the sleeve member including the front surface 216 and back surface 218 that with the first and second side rails 214A and 214B define an open interior. The interior of the sleeve provides a space into which a pad 222 may be inserted.

Disposition of a complaint or compressible pad 222 below the front surface 212 (e.g., within the interior of the sleeve 216) provides further potential energy dissipation for the carrier. As illustrated in FIG. 5C, the pad 222 may be formed of a single element that is sized for receipt within the sleeve between the side rails 214A, 214B. Alternatively, as illustrated in FIG. 5D, the pad 222 may be formed of multiple separate elements that are disposed along the length of the sleeve between the first and second ends of the ramp 200. In any arrangement, it may be preferable that these pads 222 are easily compressible to allow for dissipation of potential energy. In one arrangement, the pads are formed of an open cell foam. In another arrangement, the pads may be formed of a closed cell foam, fabric padding or other deflectable materials.

In operation, the open frame defined by the side rails 214A, 214B and the compliant front surface 212 allow a carrier 100 to sink into the top surface 212 and thereby reduce or absorb the potential energy of the carrier. As shown in FIG. 5G, upon being contacted by a carrier 100, the top surface 212 and pad 222 (if utilized) deflect from a static position (See FIG. 5F) to a deflected position (See FIG. 5G) in conjunction with the side rails 214A, 214B deflectin inward toward one another. This compression of the carrier into the front surface 212 of the ramp 200 both absorbs the potential energy of the carrier and slows the subsequent sliding of the carrier down the ramp 200.

In one embodiment the front surface 212 may further include first and second seams 224A and 224B that extend between the first and second ends of the ramp. See FIG. 5E. These seams 224 extend above the front surface 216 form a guide between the first and second ends of the ramp 200. In this regard, when the ramp 200 receives a carrier 100, the front end of the carrier is maintained between these seams as it slides to the second end 204 of the ramp.

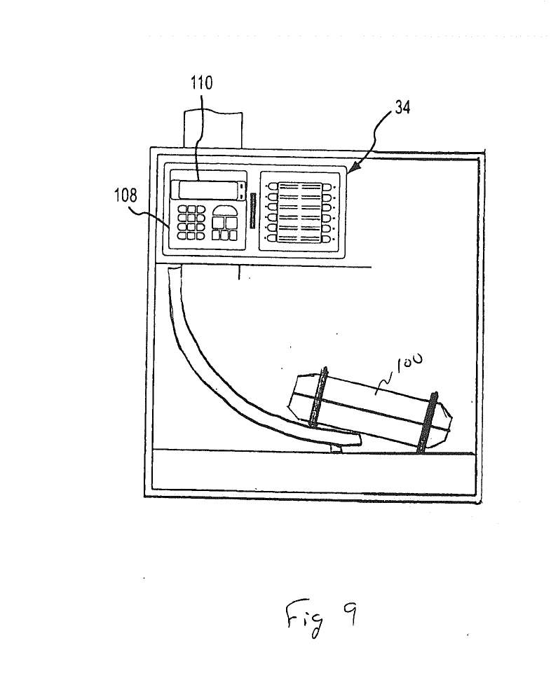

FIGS. 7-9 illustrates the receipt of a carrier 100 into a station 116 incorporating the ramp 200. Initially, the carrier enters the station through the input port 118. Preferably, the ramp 200 is positioned such that a wear band 44 (or potentially end surface of the carrier) contacts the front surface of the ramp 200 prior to the carrier being completely released from the incoming pneumatic tube 122. That is, the carrier 100 is in contact with the ramp prior to being released where it is allowed to continue under the force of gravity. To permit contact prior to carrier release, the front surface of the ramp is positioned at a horizontal distance d, that is equal or slightly less than the radius of the carrier 100 as measured from its centerline axis Z-Z¹. See FIG. 7. This arrangement allows the deflectable front surface 212 to contact and cradle the carrier and thereby permit is to slowly descend into the station 116. FIG. 8 illustrates the carrier 100 as it descends into the station and FIG. 9 illustrates the carrier 100 as it is received in the bin 120. In the embodiment illustrated in FIGS. 7-9, the carrier slides into the station in a controlled fashion.

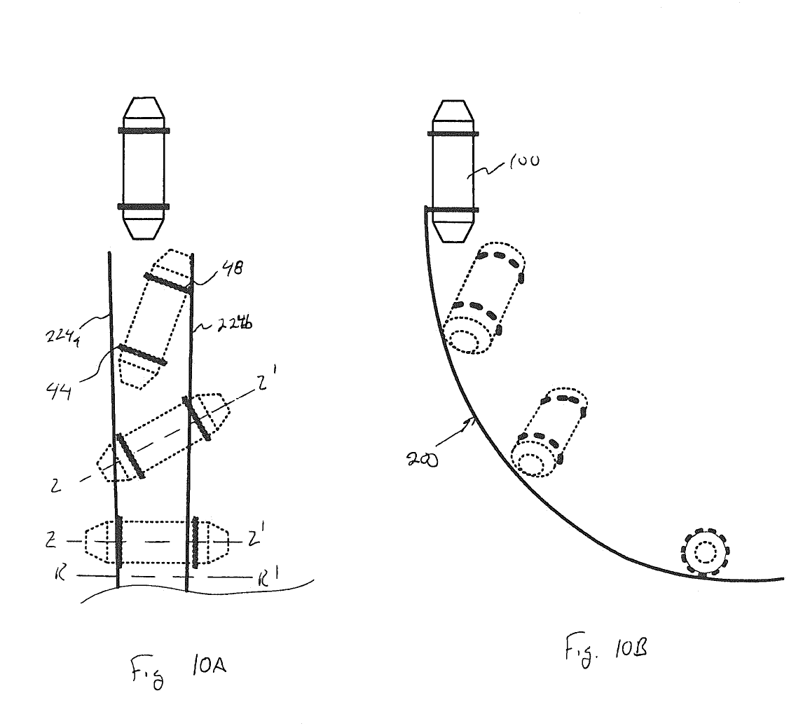

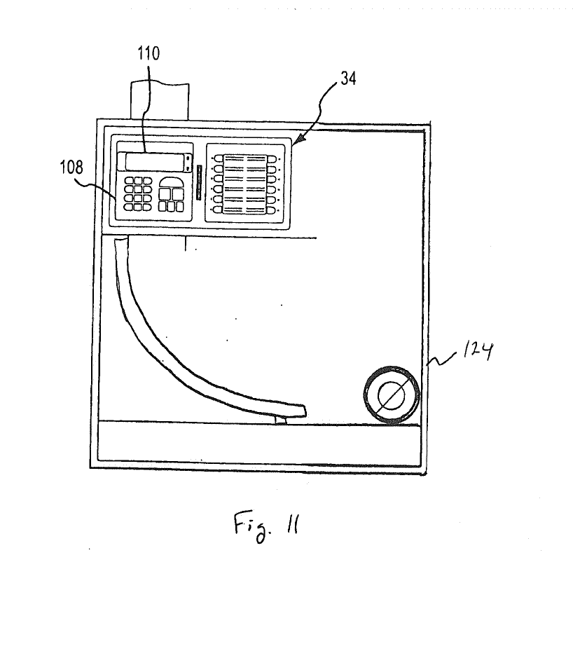

In a further arrangement, the ramp 200 allows for the carrier to slide into the station in a controlled manner and turn such along the ramp such that the centerline axis of the carrier is substantially aligned with a reference line R-R₁ extending between the second ends of the side rails of the ramp. See FIGS. 5A, 10A and 10B. Substantial alignment of the central axis of the carrier Z-Z¹ with the reference axis R-R¹ includes all orientations where a major component of the central axis is primarily aligned with the reference axis R-R¹. That is, the central axis Z-Z¹ and reference axis R-R¹ need not be parallel. The ability to turn the carrier as it descends allows it to roll against the side wall of the station 124 (See FIG. 11). In this regard, the carrier 100 is able to descend, turn and roll into the station. This allows translating vertical motion of the carrier into a rotational motion further reducing impacts on the carrier and its contents.

Such roll out functionality of the carrier is provided in the first embodiment by tapering the side rails as illustrated in FIG. 5B. As shown, the side rails 214A and 214B have a narrower spacing on the second end 204 than on the first end 202. In this regard, as the carrier 100 descends down the front surface 216 of the ramp 200 the front end of the carrier is maintained between the first and second seems 224A and 224B. However, when the second end of the carrier is released from the input port 118 the second end is typically able to fall forward or back relative to the face of the ramp and turn from a first orientation to a second orientation. More specifically, the front wear band 44 on the front end of the carrier tends to move into contact with one of the seams 224A or 224B as the carrier moves down the ramp 200. This seam (224 as shown in FIG. 11) prevents the front wear band 44 from passing over. However, the rear wear band 48 is typically able to pass over the other seam 224B as the backend of the carrier does not compress into the ramp to the extent of the front end of the carrier does. This allows the carrier to turn from a generally vertical orientation as shown in FIG. 10A to a generally horizontal position. Accordingly, by the time the carrier reaches the bottom of the ramp, the carrier is positioned such that it may roll out to the far end of the receiving bin as illustrated in FIGS. 10B and 11. This roll out ability of the carrier provides several benefits. Specifically, by allowing the carriers to roll across the bin, the carriers are moved away from the position where they may be contacted by subsequent incoming carriers or such contact is significantly reduced. Furthermore, this arrangement allows for identifying the order in which the carriers are received within the carrier station. In this latter regard, personnel receiving the carriers may attend to them in the order that they are received.

Variations exist to the station ramp discussed above. For instance, though discussed primarily in use with an open frame and a deflectable front surface, it will be appreciated that aspects of the disclosure may be utilized with a solid front surface as well. For instance, the ramp may have a solid and tackified surface such that the front wear band, where most the weight resides is restricted in its travel allowing a rearward position of the carrier to fall rotate about the central axis of the carrier and turn into a roll out position.

The foregoing description has been presented for purposes of illustration and description. Furthermore, the description is not intended to limit the invention to the form disclosed herein. Consequently, variations and modifications commensurate with the above teachings, and skill and knowledge of the relevant art, are within the scope of the various embodiments. The embodiments described hereinabove are further intended to explain best modes known of practicing the invention and to enable others skilled in the art to utilize the invention in such, or other embodiments and with various modifications required by the particular application(s) or use(s) of the various embodiments. It is intended that the appended claims be construed to include alternative embodiments to the extent permitted by the prior art.

1. A dispatch/receive station for a pneumatic carrier transport system in which carriers are transported throughout the pneumatic system, the station comprising:
a carrier port for receiving carriers into the station;
a receiving surface where carriers received by the station come to a rest, wherein the carrier receiving surface is below the carrier port and carriers pass between the carrier port and the receiving surface under the force of gravity;
a ramp including;
a first end disposed proximate to the carrier port;
a second end disposed proximate to said receiving surface; and
a curved body portion extending between the first end and second end, wherein carriers received via said port, in a substantially vertical orientation at said first end, slide down a surface of said curved body to the second end of the ramp where the carriers come to rest in a substantially horizontal orientation.

2. The station of claim 1, wherein an upper portion of the ramp proximate to said first end has a vertical component that is greater than a horizontal component and a lower portion of said ramp proximate to said second end has a horizontal component greater than a vertical component.

3. The station of claim 1, wherein said ramp further comprises:
an open frame having first and second side rails disposed in a spaced relationship extending between said first end and said second end; and
said surface comprises a compliant surface extending over said open frame between said first and second rails, wherein carriers received via said inlet port contact said compliant surface.

4. The station of claim 3, wherein a rigidity of said first and second side rails is greater than a rigidity of said compliant surface.

5. (canceled)

6. (canceled)

7. The station of claim 3, wherein said compliant surface deflects from a static position to a deflected position in response to the weight of a pneumatic carrier being disposed on said compliant surface.

8. The station of claim 3, wherein said compliant surface further comprises:
a sleeve member, wherein said sleeve member is disposed around said first and second side rails defining an interior space between front and back surfaces of the sleeve between said first and second rails.

9. The station of claim 8, further comprising:
a pad formed of a compressible material disposed in said interior space of said sleeve member.

10. (canceled)

11. (canceled)

12. The station of claim 3, where said first and second rails are disposed in a spaced parallel relationship.

13. The station of claim 3, wherein said first and second rails are disposed in at an non-parallel angle to one another.

14. (canceled)

15. The station of claim 1, wherein said surface further comprises:
first and second guides extending over at least a portion of the body of said ramp between said first and second ends, wherein said guides extend above said surface.

16. (canceled)

17. The station of claim 1, wherein a first end of said surface proximate to said first end of said ramp is disposed a horizontal distance from a centerline axis of said carrier port, wherein said horizontal distance is less than a maximum radius of a carrier that is sized for transport through said carrier port.

18. A method for use in a pneumatic dispatch/receive station of a pneumatic carrier transport system, comprising:
receiving a carrier at an inlet port of a pneumatic carrier station, wherein said port is disposed vertically above a receiving surface where the carrier received by the station comes to a rest;
descending the carrier through said inlet port;
contacting a portion of the carrier descending through said port with a surface of a curved ramp having a first end attached proximate to said inlet port and a second end disposed proximate to said receiving surface; and
sliding the carrier down the surface of the ramp where the carrier translated from a first orientation where a vertical component of a centerline axis of the carrier is greater than a horizontal component of the centerline axis to a second orientation wherein a horizontal component of said centerline axis is greater than a vertical component of the centerline axis.

19. The method of claim 18, wherein said contacting occurs prior to said carrier being released by said inlet port.

20. The method of claim 18, wherein contacting further comprises:
deflecting the surface of said curved ramp, wherein said surface deflects in response to the weight of said carrier being supported by said surface.

21. The method of claim 20, wherein deflecting comprises deflecting a compliant surface that extends between first and second spaced side rails of said ramp that extend between said first and second ends of said ramp.

22. (canceled)

23. (canceled)

24. (canceled)

25. A ramp for use with a dispatch/receive station of a pneumatic carrier transport system where the station includes a carrier port for receiving carriers into the station that is disposed above a receiving surface where carriers received by the station come to a rest, comprising:
an open frame including first and second side rails disposed in a spaced relationship, wherein each of said side rails include a first end connectable proximate to the inlet port of the station, a second end connectable proximate to the receiving surface of the station and a body portion extending between said first and second ends;
a compliant surface extending over a spacing between said first and second rails and extending along at least a portion of the side rails between said first and second ends, wherein carriers received via said inlet port contact said compliant surface.

26. The ramp of claim 25, wherein upper portions of said side rails proximate to said first ends have a vertical component that is greater than a horizontal component and lower portions of said side rails proximate to said second ends have a horizontal component greater than a vertical component.

27. (canceled)

28. (canceled)

29. (canceled)

30. (canceled)

31. The ramp of claim 25, wherein said compliant surface deflects from a static position to a deflected position in response to the weight of a pneumatic carrier being disposed on said compliant surface.

32. The ramp of claim 25, wherein said compliant surface further comprises:
a sleeve member, wherein said sleeve member is disposed around said first and second side rails defining an interior space between front and back surfaces of the sleeve between said first and second rails.

33. The station of claim 33, further comprising:
a pad formed of a compressible material disposed in said interior space of said sleeve member.

34. (canceled)

35. (canceled)
